(19) United States
(12) Patent Application Publication
(10) Pub. No.: US 2026/0161167 A1
(43) Pub. Date: Jun. 11, 2026

(54) UAV Flight Height Control Method and Apparatus, Electronic Device, and Storage Medium

(71) Applicant: Research Center of Intelligent Equipment, Beijing Academy of Agricultural and Forestry Sciences, Beijing (CN)

(72) Inventors: Ruirui ZHANG; Liping CHEN; Tongchuan YI; Longlong LI; Qing TANG; Peng HU

(73) Assignee: Research Center of Intelligent Equipment, Beijing Academy of Agricultural and Forestry Sciences, Beijing (CN)

(21) Appl. No.: 18/689,383

(22) PCT Filed: Dec. 13, 2023
(86) PCT No.: PCT/CN2023/138462

§ 371 Date: Mar. 5, 2024

(30) Foreign Application Priority Data
Nov. 8, 2023 (CN) 202311477495.2

(51) Int. Cl. G05D 1/48; B64U 20/80; B64U 101/30; B64U 101/40; B64U 101/45; G05D 1/243; G05D 107/20; G05D 109/25; G05D 111/10; G06V 10/10; G06V 10/40; G06V 10/75; G06V 10/764; G06V 10/774; G06V 10/776; G06V 10/82; G06V 20/10; G06V 20/17

(52) U.S. Cl. CPC G05D 1/48; B64U 20/80; G05D 1/243; G06V 10/16; G06V 10/40; G06V 10/751; G06V 10/764; G06V 10/774; G06V 10/776; G06V 10/82; G06V 20/17; G06V 20/188; B64U 2101/30; B64U 2101/40; B64U 2101/45; G05D 2107/21; G05D 2109/254; G05D 2111/10

(57) ABSTRACT

The present disclosure provides an unmanned aerial vehicle (UAV) flight height control method and apparatus, an electronic device, and a storage medium, and pertains to the field of agricultural technologies. The method includes: obtaining crop lodging information of a crop lodging area beneath a UAV during a flight; inputting the crop lodging information into a UAV flight height prediction model to obtain a target flight height output by the UAV flight height prediction model, where the UAV flight height prediction model is obtained by training a deep neural network model based on a crop lodging information sample and a UAV flight height label corresponding to the crop lodging information sample; and controlling the UAV to fly at the target flight height.

### TECHNICAL FIELD

The present disclosure relates to the field of agricultural technologies, and in particular, to a UAV flight height control method and apparatus, an electronic device, and a storage medium.

### BACKGROUND

A plant protection unmanned aerial vehicle (UAV) features wide topographic adaptability and high operating efficiency. The plant protection UAV has developed rapidly in China in recent years, and has become an important tool for pest and disease control in agriculture and forestry. A flight height of the plant protection UAV significantly affects quality of pesticide application. If the plant protection UAV flies excessively high, pesticide may easily drift away, which reduces pesticide utilization and causes secondary pesticide contamination. If it flies excessively low, crop canopies may be easily damaged due to a downwash airflow generated by the plant protection UAV. Therefore, decision-making on an optimal flight height of the plant protection UAV is crucial.

Currently, the flight height of the plant protection UAV mainly depends on a flight safety requirement, and a distance between the UAV and a crop canopy is measured by using tools such as an altimeter, an ultrasonic sensor, and a laser radar. However, the foregoing existing height measurement tools can measure merely a relative distance between the UAV and the crop, and cannot reflect whether a current flight height is appropriate. Consequently, pesticide application effect is not as expected.

Therefore, how to control the flight height of the plant protection UAV more effectively and improve pesticide application effect of the UAV during UAV pesticide application is a technical problem to be urgently resolved in the industry.

### SUMMARY

The present disclosure provides a UAV flight height control method and apparatus, an electronic device, and a storage medium, to more effectively control a flight height of a plant protection UAV and improve pesticide application performance of the UAV during pesticide application of the UAV.

The present disclosure provides a UAV flight height control method, including:

obtaining crop lodging information of a crop lodging area beneath a UAV during a flight;

inputting the crop lodging information into a UAV flight height prediction model to obtain a target flight height output by the UAV flight height prediction model, where the UAV flight height prediction model is obtained by training a deep neural network model based on a crop lodging information sample and a UAV flight height label corresponding to the crop lodging information sample; and

controlling the UAV to fly at the target flight height.

Optionally, before the obtaining crop lodging information of a crop lodging area beneath a UAV during a flight, the method further includes:

stitching all frames of images that are of a crop planting area beneath the UAV and that are collected by the UAV during the flight, to obtain a target image of the crop planting area;

performing spatial domain filtering on the target image of the crop planting area, to obtain an image of the crop lodging area; and

extracting the crop lodging information from the image of the crop lodging area.

Optionally, the extracting the crop lodging information from the image of the crop lodging area includes:

extracting, from the image of the crop lodging area, crop lodging feature information of each crop;

performing feature matching between the crop lodging feature information and a preset crop lodging feature database, to determine crop lodging angle information of the crop lodging area; and

determining the crop lodging information based on the crop lodging angle information of the crop lodging area.

Optionally, the performing feature matching between the crop lodging feature information and a preset crop lodging feature database to determine crop lodging angle information of the crop lodging area includes:

performing feature matching between the crop lodging feature information of each crop and the preset crop lodging feature database, to obtain lodging angle information of each crop; and

calculating an average value of lodging angle information of all crops, to obtain the crop lodging angle information of the crop lodging area.

Optionally, after the crop lodging angle information of the crop lodging area is determined, the method further includes:

obtaining type information and growth period information of crops in the crop lodging area; and

obtaining the crop lodging information based on the crop lodging angle information of the crop lodging area and the type information and the growth period information of the crops.

Optionally, a training process of the UAV flight height prediction model includes:

using, as a set of training samples, the crop lodging information sample and the UAV flight height label corresponding to the crop lodging information sample, to obtain a plurality of sets of training samples; and

training the deep neural network model based on the plurality of sets of training samples, to obtain the UAV flight height prediction model.

Optionally, the training the deep neural network model based on the plurality of sets of training samples to obtain the UAV flight height prediction model includes:

inputting any set of training samples into a deep neural network model that undergoes a current number of times of training, to output a prediction probability corresponding to the training samples under the current number of times of training;

calculating, by using a preset loss function, a loss value under the current number of times of training based on the prediction probability corresponding to the training samples under the current number of times of training and a UAV flight height label corresponding to the training samples;

determining whether a termination condition is met, where the termination condition is: the loss value under the current number of times of training is less than a preset threshold or the current number of times of training reaches a preset number of times of training; and

if the termination condition is met, determining, as the UAV flight height prediction model, the deep neural network model that undergoes the current number of times of training; or

if the termination condition is not met, tuning parameters of the deep neural network model that undergoes the current number of times of training, and returning to the step “inputting any set of training samples into a deep neural network model that undergoes a current number of times of training, to output a prediction probability corresponding to the training samples under the current number of times of training”, until the termination condition is met.

A UAV flight height control apparatus is provided, including:

an obtaining module, configured to obtain crop lodging information of a crop lodging area beneath a UAV during a flight;

a prediction module, configured to input the crop lodging information into a UAV flight height prediction model to obtain a target flight height output by the UAV flight height prediction model, where the UAV flight height prediction model is obtained by training a deep neural network model based on a crop lodging information sample and a UAV flight height label corresponding to the crop lodging information sample; and

a control module, configured to control the UAV to fly at the target flight height.

The present disclosure further provides an electronic device, including a memory, a processor, and a computer program that is stored in the memory and able to run in the processor. When the program is executed by the processor, the UAV flight height control method according to any one of the foregoing optional implementations is implemented.

The present disclosure further provides a storage medium, storing a computer program. When the computer program is executed by a processor, the UAV flight height control method according to any one of the foregoing optional implementations is implemented.

According to specific embodiments provided in the present disclosure, the present disclosure has the following technical effects:

The present disclosure provides a UAV flight height control method and apparatus, an electronic device, and a storage medium. The present disclosure fully explores an internal relationship between a UAV flight height and crop lodging information, and trains a deep neural network model by using a large number of crop lodging information samples and UAV flight height labels corresponding to the crop lodging information samples, to obtain a UAV flight height prediction model. In this way, when crop lodging information of the crop lodging area is input into the UAV flight height prediction model, a target flight height for efficient pesticide application can be effectively predicted. Then, the UAV can be controlled to perform pesticide application by flying at the target flight height. This ensures that a crop lodging degree is always within an appropriate range, thereby achieving optical pesticide application performance. This significantly improves performance of a plant protection UAV in performing pesticide application on the crops, and enhances pesticide utilization.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a schematic flowchart of a UAV flight height control method according to Embodiment 1 of the present disclosure;

FIG. 2 is a schematic diagram of a structure of a UAV flight height control apparatus according to Embodiment 2 of the present disclosure; and

FIG. 3 is a schematic diagram of a physical structure of an electronic device according to Embodiment 3 of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely some rather than all of the embodiments of the present disclosure. All other embodiments obtained by those skilled in the art based on the embodiments of the present disclosure without creative efforts shall fall within the protection scope of the present disclosure.

The present disclosure aims to provide a solid waste identification method, a system, and an electronic device, so as to improve identification accuracy of a solid waste.

In order to make the above objective, features and advantages of the present disclosure clearer and more comprehensible, the present disclosure is further described in detail below in combination with accompanying drawings and particular implementation modes.

### Embodiment 1

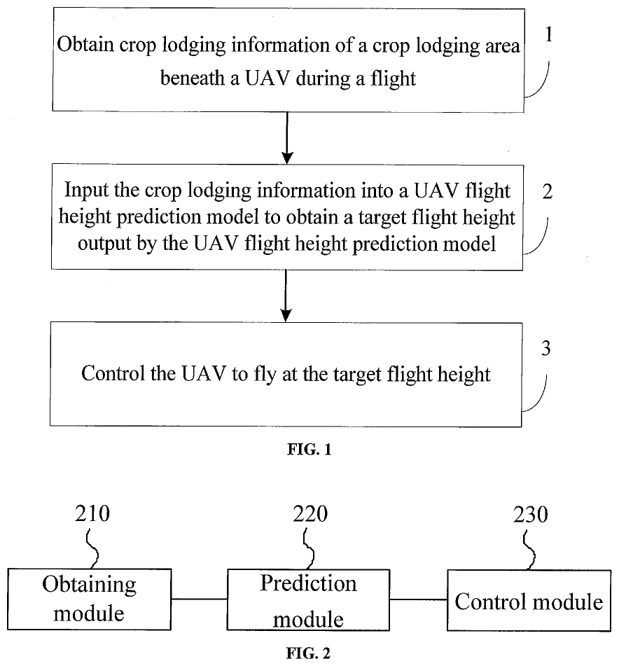

FIG. 1 is a schematic flowchart of a UAV flight height control method according to Embodiment 1 of the present disclosure. As shown in FIG. 1, the UAV flight height control method in this embodiment includes the following steps:

Step 1: Obtain crop lodging information of a crop lodging area beneath a UAV during a flight.

Specifically, the crop lodging area is an area in which crops beneath a plant protection UAV lodge due to a downwash airflow from the UAV when the plant protection UAV flies to perform pesticide application. The crop lodging information is feature information used to demonstrate a crop lodging degree, including but not limited to lodging angle information, lodging location information, and lodging posture information.

Further, in Step 1, a remote sensing image capture module may be mounted to a lower part of the UAV in advance. The remote sensing image capture module is used to obtain information such as a crop lodging degree and location, and a posture image of the crop lodging area beneath the UAV during the flight. A gimbal and an image sensor are mounted to the lower part of the UAV, to connect to a terrestrial station of the UAV or configure a camera based on a preset configuration file.

The remote sensing image capture module mainly includes the image sensor, a stabilized gimbal, an image capture controller, the terrestrial station, and the like. The image sensor is used to capture visible light images of crop lodging states from different angles and depths. Then, obtained image information is analyzed and processed through a computer vision algorithm module. Subsequently, a processed image is further processed by an image processing module, to identify and analyze information such as an angle, a location, and a posture of crop lodging caused due to the downwash airflow from the UAV during the flight.

It should be noted that there is a lag phenomenon in a canopy area during the flight of the plant protection UAV. Therefore, an angle of the image sensor needs to be adjusted in real time based on a flight speed through a tracking control algorithm, so as to obtain a complete image of a crop canopy disturbance area, namely, the crop lodging area.

Step 2: Input the crop lodging information into a UAV flight height prediction model to obtain a target flight height output by the UAV flight height prediction model.

The UAV flight height prediction model is obtained by training a deep neural network model based on a crop lodging information sample and a UAV flight height label corresponding to the crop lodging information sample.

Specifically, the UAV flight height prediction model is used to identify different crop lodging information and learn an optimal UAV flight height to be adjusted to when different crop lodging information is used. At the optimal UAV flight height, damage caused due to an airflow from the UAV is minimized, and pesticide application efficiency and pesticide utilization are high. In this way, the UAV flight height prediction model can predict the corresponding optimal UAV flight height based on different crop lodging information.

The deep neural network model may be a deep convolutional neural network (Convolutional Neural Network, CNN), a deep learning U-Net network, or the like. Alternatively, the deep neural network model may be another neural network for crop lodging information identification and UAV flight height control. This is not specifically limited in the present disclosure.

It should be noted that in this embodiment of the present disclosure, a UAV flight height can be defined as a distance from the UAV to a crop canopy.

Training samples consist of a plurality of sets of crop lodging information samples that carry UAV flight height labels.

The UAV flight height labels in this embodiment of the present disclosure are predetermined based on the crop lodging information samples and are in a one-to-one correspondence with the crop lodging information samples. In other words, it is predetermined that each crop lodging information sample in the training samples carries one UAV flight height label corresponding to the crop lodging information sample.

The target flight height in this embodiment of the present disclosure is the foregoing optimal UAV flight height at which a downwash airflow from the UAV causes little damage to crops and pesticide application efficiency and pesticide utilization are high.

Step 3: Control the UAV to fly at the target flight height.

Further, in Step 3, the flight height of the UAV can be regulated. To be specific, the UAV can be controlled to fly at the target flight height, so as to control pesticide application operations performed by the UAV on crops beneath the UAV.

In an optional implementation, before Step 1, the method further includes:

Step 01: Stitch all frames of images that are of a crop planting area beneath the UAV and that are collected by the UAV during the flight, to obtain a target image of the crop planting area.

Specifically, the target image of the crop planting area is an image that fully covers crop lodging conditions in the crop planting area from different angles. The target image is obtained by stitching all high-resolution digital images obtained by the UAV hovering over the crop planting area to capture images of lodging crops from different angles.

Images captured by the image sensor are stored in a tag image file format (TIFF) format, which retains grayscale information of red, green, and blue colors of a surface feature. Each color includes eight-bit byte information, with a value range from 0 to 255. Then, the captured images are cropped and stitched, to obtain the target image of the crop planting area. Further, the target image of the crop planting area is preprocessed, including operations such as noise removal, image projection calibration, and contrast improvement. This facilitates subsequent analysis and measurement of a crop lodging angle.

Step 02: Perform spatial domain filtering on the target image of the crop planting area, to obtain an image of the crop lodging area.

Specifically, in order to highlight a difference between the crop lodging area and a non-lodging area in the image, spatial domain filtering needs to be further performed on the target image of the crop planting area for image enhancement, so as to obtain the image of the crop lodging area. In addition, second-order low-pass filtering may be further performed to effectively suppress image noise and reduce computational complexity. Spatial domain filtering is performed on the target image of the crop planting area to highlight the difference between the crop lodging area and the non-lodging area in the image, so that the image of the crop lodging area can be rapidly obtained. This can effectively improve efficiency and accuracy of extracting crop lodging information from the image of the crop lodging area.

Step 03: Extract the crop lodging information from the image of the crop lodging area.

Specifically, an image processing algorithm or an artificial intelligence (AI) technology, such as blob detection or edge detection, can be used to extract crop lodging features. Then, the extracted features are analyzed to calculate the crop lodging information such as the crop lodging angle. For example, the crop lodging information may be extracted by using a technology such as a feature matching method, a geometric analysis method, a machine learning algorithm, or a deep learning model. Further, the calculated crop lodging angle may be visualized in a graphical manner, for example, by drawing a lodging direction, representing a lodging direction through an arrow, or the like. Crops differ in degrees of lodging caused by a downwash airflow from the plant protection UAV. Therefore, crop lodging degrees are comprehensively evaluated in combination with agronomic trait information such as growth period information of the crops.

In an optional implementation, Step 03 includes:

Step 031: Extract, from the image of the crop lodging area, crop lodging feature information of each crop.

Specifically, the crop lodging feature information of each crop is extracted from the image of the crop lodging area, which enhances diversity of crop lodging images.

Step 032: Perform feature matching between the crop lodging feature information and a preset crop lodging feature database, to determine crop lodging angle information of the crop lodging area.

Specifically, the preset crop lodging feature database is a preset database for crop lodging feature matching.

Feature matching is performed between the crop lodging feature information and the preset crop lodging feature database, to search the preset crop lodging feature database for crop lodging feature data that successfully matches the crop lodging feature information. In this way, information about a corresponding crop lodging status can be determined based on the crop lodging feature data, and the crop lodging angle information of the crop lodging area can be obtained. Then, the crop lodging angle information is used as crop lodging information to be subsequently input into the model.

A feature matching method is used to perform feature matching between the crop lodging feature information and the preset crop lodging feature database, so that the crop lodging angle information of the crop lodging area can be effectively determined. This improves accuracy in extracting the crop lodging angle information, which helps improve accuracy in subsequently calculating an operation flight height of the UAV based on the crop lodging information.

Step 033: Determine the crop lodging information based on the crop lodging angle information of the crop lodging area.

In an optional implementation, Step 032 includes:

Perform feature matching between the crop lodging feature information of each crop and the preset crop lodging feature database, to obtain lodging angle information of each crop.

Calculate an average value of lodging angle information of all crops, to obtain the crop lodging angle information of the crop lodging area.

Specifically, feature matching is performed between the crop lodging feature information of each crop and the preset crop lodging feature database. Through one-to-one matching, a crop lodging feature that matches the obtained crop lodging angle information of each crop can be obtained from the preset crop lodging feature database.

Further, in order to demonstrate the crop lodging angle information of the crop lodging area, the average value of the lodging angle information of all crops is calculated. In this way, a lodging angle for all crops is calculated, and the crop lodging angle information of the crop lodging area is obtained.

Further, the average value of the lodging angle information of all crops is calculated. In this way, an average lodging angle for all crops in the crop lodging area is calculated, and the average lodging angle is used as the crop lodging angle information of the crop lodging area.

The feature matching method is used to determine the lodging angle information of each crop. In addition, the average value of the lodging angle information of all crops is calculated, to evaluate an overall lodging degree of the crops in the crop lodging area. This can effectively demonstrate the crop lodging angle information of the crop lodging area, and improves accuracy in calculating lodging information of the crop lodging area.

In an optional implementation, after Step 032, the method further includes the following steps:

Obtain type information and growth period information of crops in the crop lodging area.

Obtain the crop lodging information based on the crop lodging angle information of the crop lodging area and the type information and the growth period information of the crops.

It should be noted that the whole growth period of a crop is divided into a vegetative growth period that focuses on growth of vegetative organs such as roots, stems, and leaves, and a reproductive growth period that focuses on differentiation of reproductive organs such as flowers, fruits, and seeds. For example, for a cereal crop, a period before young spike differentiation is considered as the vegetative growth period; a period from young spike differentiation to heading is considered as a period in which vegetative growth and reproductive growth coexist; and a period after heading is purely considered as the reproductive growth period.

Specifically, after the crop lodging angle information of the crop lodging area is determined, the type information and the growth period information of the crops in the crop lodging area need to be further obtained. Then, the crop lodging information is obtained based on the crop lodging angle information of the crop lodging area and the type information and the growth period information of the crops. Therefore, the UAV flight height prediction model is obtained through training based on a crop lodging angle information sample, a corresponding crop type information sample and growth period information sample, and a corresponding UAV flight height label. Agronomic trait information of the crops is considered, to comprehensively evaluate the crop lodging degree and determine the crop lodging information. Then, the crop lodging information is identified, to determine an appropriate operation flight height for the UAV.

In an optional implementation, a training process of the UAV flight height prediction model includes the following steps:

Use, as a set of training samples, the crop lodging information sample and the UAV flight height label corresponding to the crop lodging information sample, to obtain a plurality of sets of training samples.

Train the deep neural network model based on the plurality of sets of training samples, to obtain the UAV flight height prediction model.

Specifically, 15% of total crop lodging information samples can be used as a test set, 70% of the total crop lodging information samples are used as a training set, and the remaining 15% of the total crop lodging information samples are used as a validation set. A name of each crop lodging information sample is recorded. Then, a corresponding UAV flight height label is appended to the name, and an obtained result is saved in a CSV file.

In an optional implementation, that the deep neural network model is trained based on the plurality of sets of training samples to obtain the UAV flight height prediction model includes the following steps:

Input any set of training samples into a deep neural network model that undergoes a current number of times of training, to output a prediction probability corresponding to the training samples under the current number of times of training.

Calculate, by using a preset loss function, a loss value under the current number of times of training based on the prediction probability corresponding to the training samples under the current number of times of training and a UAV flight height label corresponding to the training samples.

Determine whether a termination condition is met. The termination condition is: the loss value under the current number of times of training is less than a preset threshold or the current number of times of training reaches a preset number of times of training.

If the termination condition is met, determine, as the UAV flight height prediction model, the deep neural network model that undergoes the current number of times of training.

If the termination condition is not met, tune parameters of the deep neural network model that undergoes the current number of times of training, and return to the step “input any set of training samples into a deep neural network model that undergoes a current number of times of training, to output a prediction probability corresponding to the training samples under the current number of times of training”, until the termination condition is met.

Specifically, after the loss value under the current number of times of training is obtained, the current training process ends. Then, an algorithm such as a back propagation (Back Propagation, BP) algorithm is used to tune, based on the loss value under the current number of times of training, the parameters of the deep neural network model that undergoes the current number of times of training, to update a weight parameter at each layer of the deep neural network model that undergoes the current number of times of training. Then, a next training process is performed. In this way, model training is performed iteratively.

In the training process, if a training result for a specific set of training samples satisfies the preset termination condition, for example, if a corresponding calculated loss value is less than the preset threshold or a current number of iterations reaches a preset number of iterations, the loss value of the model can be controlled within a convergence range. Then, model training ends. In this case, obtained model parameters can be used as model parameters of a trained UAV flight height prediction model. Then, training of the UAV flight height prediction model is completed, and the trained UAV flight height prediction model is obtained.

### Specific Embodiment

To verify the method in Embodiment 1, in the specific embodiment, the following information is first input into an optimal operation flight height system of the plant protection UAV: a type of a crop as wheat, a growth period of the crop, and an agronomic trait indicator of the crop. Then, latitude and longitude, and operation data and time are input.

The airborne remote sensing image capture module automatically tunes capture parameters, and tunes focus and exposure parameters of the image sensor for the wheat. Then, the camera is configured. Specifically, the camera is configured through the terrestrial station connected to the UAV or based on a preset configuration file.

The plant protection UAV flies to a preset initial flight height H1 to perform flight operations, obtains high-resolution visible-light aerial images of the wheat through the image sensor, transmits lodging image information of the wheat to the image processing module of the terrestrial station, to stitch and preprocess wheat lodging aerial images and generate a necessary digital surface model (Digital Surface Model, DSM) and a necessary digital orthophoto map (Digital Orthophoto Map, DOM). In order to highlight a difference between a wheat lodging area and a non-lodging area in the image, spatial domain filtering needs to be performed for image enhancement of the DOM. Then, a K-means algorithm, a genetic neural network algorithm, and a skeleton algorithm are used to obtain the wheat lodging area. In order to effectively represent texture information and reduce computational complexity, second-order low-pass filtering is performed on a panchromatic band.

Further, feature matching is performed to estimate wheat lodging angle information. First, some features, such as corners or texture features, are extracted from a visible-light wheat lodging image. Then, feature matching is performed based on images captured from different perspectives, to calculate a relative wheat lodging angle. Subsequently, offsets and spatial distribution of matching points are analyzed, to further estimate wheat lodging angle information.

A deep learning module is used to train a model related to a flight height and a wheat lodging angle, and wheat lodging degrees are classified (specifically, the wheat lodging degrees are classified into four levels: a severe level with a lodging degree less than or equal to 15°, a medium level with a lodging degree greater than 15° but less than 45°, a light level with a lodging degree greater than 45° but less than 70°, and a non-lodging level with a lodging degree greater than 70°) During operations, a wheat lodging degree is evaluated in real time based on obtained wheat lodging image information, and a target flight height is controlled in real time. When the wheat lodging degree is equal to 70°, a flight height currently output by a flight height decision-making module is a critical height H2. During flight operations, if the wheat lodging degree is less than 70°, the UAV is controlled to ascend to the critical height. If the wheat lodging degree is greater than 70°, the UAV is controlled to descend to the critical height. In this way, the wheat lodging degree can be always kept within an appropriate range. This significantly improves performance of pesticide application operations performed on the wheat by the plant protection UAV, and enhances pesticide utilization.

The UAV flight height control method in Embodiment 1 of the present disclosure fully explores an internal relationship between a UAV flight height and crop lodging information, and trains a neural network model by using a large number of crop lodging information samples and UAV flight height labels corresponding to the crop lodging information samples, to obtain the UAV flight height prediction model. In this way, when crop lodging information of the crop lodging area is input into the UAV flight height prediction model, a target flight height for efficient pesticide application can be effectively predicted. Then, the UAV can be controlled to perform pesticide application by flying at the target flight height. This ensures that a crop lodging degree is always within an appropriate range, thereby achieving optical pesticide application performance. This significantly improves performance of a plant protection UAV in performing pesticide application on the crops, and enhances pesticide utilization.

### Embodiment 2

FIG. 2 is a schematic diagram of a structure of a UAV flight height control apparatus according to Embodiment 2 of the present disclosure. As shown in FIG. 2, the UAV flight height control apparatus in this embodiment includes an obtaining module 210, a prediction module 220, and a control module 230.

The obtaining module 210 is configured to obtain crop lodging information of a crop lodging area beneath a UAV during a flight.

The prediction module 220 is configured to input the crop lodging information into a UAV flight height prediction model to obtain a target flight height output by the UAV flight height prediction model. The UAV flight height prediction model is obtained by training a deep neural network model based on a crop lodging information sample and a UAV flight height label corresponding to the crop lodging information sample.

The control module 230 is configured to control the UAV to fly at the target flight height.

In an optional implementation, the apparatus further includes a stitching module, a filtering module, and an extraction module.

The stitching module is configured to stitch all frames of images that are of a crop planting area beneath the UAV and that are collected by the UAV during the flight, to obtain a target image of the crop planting area.

The filtering module is configured to perform spatial domain filtering on the target image of the crop planting area, to obtain an image of the crop lodging area.

The extraction module is configured to extract the crop lodging information from the image of the crop lodging area.

In an optional implementation, the extraction module further includes an extraction submodule, a matching submodule, and a first processing submodule.

The extraction submodule is configured to extract, from the image of the crop lodging area, crop lodging feature information of each crop.

The matching submodule is configured to perform feature matching between the crop lodging feature information and a preset crop lodging feature database, to determine crop lodging angle information of the crop lodging area.

The first processing submodule is configured to determine the crop lodging information based on the crop lodging angle information of the crop lodging area.

In a possible implementation, the matching submodule is specifically configured to:

perform feature matching between the crop lodging feature information of each crop and the preset crop lodging feature database, to obtain lodging angle information of each crop; and

calculate an average value of lodging angle information of all crops, to obtain the crop lodging angle information of the crop lodging area.

In an optional implementation, the apparatus further includes an obtaining submodule and a second processing submodule.

The obtaining submodule is configured to obtain type information and growth period information of crops in the crop lodging area.

The second processing submodule is configured to obtain the crop lodging information based on the crop lodging angle information of the crop lodging area and the type information and the growth period information of the crops.

In an optional implementation, the apparatus further includes a third processing submodule and a training submodule.

The third processing submodule is configured to use, as a set of training samples, the crop lodging information sample and the UAV flight height label corresponding to the crop lodging information sample, to obtain a plurality of sets of training samples.

The training submodule is configured to train the deep neural network model based on the plurality of sets of training samples, to obtain the UAV flight height prediction model.

In a possible implementation, the training submodule is specifically configured to:

input any set of training samples into a deep neural network model that undergoes a current number of times of training, to output a prediction probability corresponding to the training samples under the current number of times of training; and

calculate, by using a preset loss function, a loss value under the current number of times of training based on the prediction probability corresponding to the training samples under the current number of times of training and a UAV flight height label corresponding to the training samples;

determine whether a termination condition is met, where the termination condition is: the loss value under the current number of times of training is less than a preset threshold or the current number of times of training reaches a preset number of times of training; and

if the termination condition is met, determine, as the UAV flight height prediction model, the deep neural network model that undergoes the current number of times of training; or

if the termination condition is not met, tune parameters of the deep neural network model that undergoes the current number of times of training, and return to the step “input any set of training samples into a deep neural network model that undergoes a current number of times of training, to output a prediction probability corresponding to the training samples under the current number of times of training”, until the termination condition is met.

### Embodiment 3

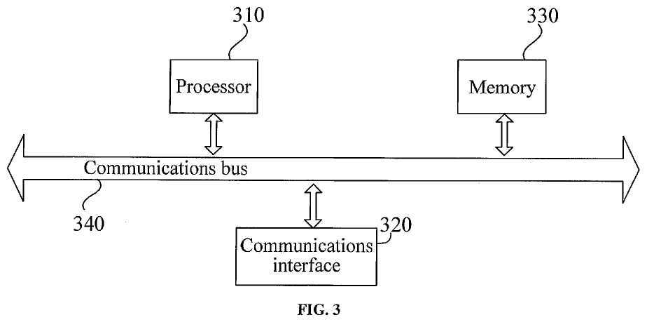

FIG. 3 is a schematic diagram of a physical structure of an electronic device according to Embodiment 3 of the present disclosure. As shown in FIG. 3, the electronic device is this embodiment includes a memory, a processor, and a computer program that is stored in the memory and able to run in the processor. When the program is executed by the processor, the UAV flight height control method according to Embodiment 1 is implemented.

Specifically, the electronic device includes a processor (processor) 310, a communications interface (Communications Interface) 320, a memory (memory) 330, and a communications bus 340. The processor 310, the communications interface 320, and the memory 330 communicate with each other through the communications bus 340. The processor 310 may invoke logic instructions in the memory 330 to execute the UAV flight height control method in Embodiment 1.

In addition, the logic instructions in the memory 330 may be implemented as a software function unit and be stored in a computer-readable storage medium when sold or used as a separate product. Based on such understanding, the technical solutions of the present disclosure essentially or the part contributing to the prior art or part of the technical solution may be implemented in a form of a software product. The computer software product is stored in a storage medium, and includes several instructions for enabling a computer device (which may be a personal computer, a server, a network device, or the like) to perform all or some steps of the method according to each of the embodiments of the present disclosure. The foregoing storage medium includes any medium that can store program code, such as a USB flash disk, a removable hard disk, a read-only memory (Read-Only Memory, ROM), a random access memory (Random Access Memory, RAM), a magnetic disk, or an optical disc.

### Embodiment 4

This embodiment provides a storage medium, storing a computer program. When the computer program is executed by a processor, the UAV flight height control method according to Embodiment 1 is implemented.

Specifically, the storage medium is a non-transient computer-readable storage medium.

### Embodiment 5

This embodiment provides a computer program product, storing a computer program. When the computer program is executed by a processor, the UAV flight height control method according to Embodiment 1 is implemented.

The apparatus embodiments described above are merely schematic, where the unit described as a separate component may or may not be physically separated, and a component displayed as a unit may or may not be a physical unit, that is, the component may be located at one place, or distributed on multiple network units. Some or all of the modules may be selected based on actual needs to achieve the objectives of the solutions of the embodiments. A person of ordinary skill in the art can understand and implement the embodiments without creative efforts.

Through the description of the foregoing implementations, a person skilled in the art can clearly understand that the implementations can be implemented by means of software plus a necessary universal hardware platform, or certainly, can be implemented by hardware. Based on such understanding, the technical solutions essentially or the part contributing to the prior art may be implemented in a form of a software product. The computer software product may be stored in a computer-readable storage medium such as a ROM/RAM, a magnetic disk, or an optical disk, and includes several instructions for enabling a computer device (which may be a personal computer, a server, a network device, or the like) to execute the method according to each of the embodiments or parts of the embodiments.

Each embodiment in the description is described in a progressive mode, each embodiment focuses on differences from other embodiments, and references can be made to each other for the same and similar parts between embodiments. Since an apparatus disclosed in the embodiments corresponds to a method disclosed in the embodiments, its description is relatively simple, and reference can be made to description of the method for relevant contents.

Particular examples are used herein for illustration of principles and implementations of the present disclosure. The descriptions of the above embodiments are merely used for assisting in understanding the method of the present disclosure and its core ideas. In addition, those of ordinary skill in the art can make various modifications in terms of particular implementations and the scope of application in accordance with the ideas of the present disclosure. In conclusion, the content of the description shall not be construed as limitations to the present disclosure.

1.-10. (canceled)

11. An unmanned aerial vehicle (UAV) flight height control method, wherein the method comprises:
obtaining crop lodging information of a crop lodging area beneath a UAV during a flight;
inputting the crop lodging information into a UAV flight height prediction model to obtain a target flight height output by the UAV flight height prediction model, wherein the UAV flight height prediction model is obtained by training a deep neural network model based on a crop lodging information sample and a UAV flight height label corresponding to the crop lodging information sample; and
controlling the UAV to fly at the target flight height.

12. The UAV flight height control method according to claim 11, wherein before the obtaining crop lodging information of a crop lodging area beneath a UAV during a flight, the method further comprises:
stitching all frames of images that are of a crop planting area beneath the UAV and that are collected by the UAV during the flight, to obtain a target image of the crop planting area;
performing spatial domain filtering on the target image of the crop planting area, to obtain an image of the crop lodging area; and
extracting the crop lodging information from the image of the crop lodging area.

13. The UAV flight height control method according to claim 12, wherein the extracting the crop lodging information from the image of the crop lodging area comprises:
extracting, from the image of the crop lodging area, crop lodging feature information of each crop;
performing feature matching between the crop lodging feature information and a preset crop lodging feature database, to determine crop lodging angle information of the crop lodging area; and
determining the crop lodging information based on the crop lodging angle information of the crop lodging area.

14. The UAV flight height control method according to claim 13, wherein the performing feature matching between the crop lodging feature information and a preset crop lodging feature database to determine crop lodging angle information of the crop lodging area comprises:
performing feature matching between the crop lodging feature information of each crop and the preset crop lodging feature database, to obtain lodging angle information of each crop; and
calculating an average value of lodging angle information of all crops, to obtain the crop lodging angle information of the crop lodging area.

15. The UAV flight height control method according to claim 13, wherein after the crop lodging angle information of the crop lodging area is determined, the method further comprises:
obtaining type information and growth period information of crops in the crop lodging area; and
obtaining the crop lodging information based on the crop lodging angle information of the crop lodging area and the type information and the growth period information of the crops.

16. The UAV flight height control method according to claim 11, wherein a training process of the UAV flight height prediction model comprises:
using, as a set of training samples, the crop lodging information sample and the UAV flight height label corresponding to the crop lodging information sample, to obtain a plurality of sets of training samples; and
training the deep neural network model based on the plurality of sets of training samples, to obtain the UAV flight height prediction model.

17. The UAV flight height control method according to claim 12, wherein a training process of the UAV flight height prediction model comprises:
using, as a set of training samples, the crop lodging information sample and the UAV flight height label corresponding to the crop lodging information sample, to obtain a plurality of sets of training samples; and
training the deep neural network model based on the plurality of sets of training samples, to obtain the UAV flight height prediction model.

18. The UAV flight height control method according to claim 13, wherein a training process of the UAV flight height prediction model comprises:
using, as a set of training samples, the crop lodging information sample and the UAV flight height label corresponding to the crop lodging information sample, to obtain a plurality of sets of training samples; and
training the deep neural network model based on the plurality of sets of training samples, to obtain the UAV flight height prediction model.

19. The UAV flight height control method according to claim 14, wherein a training process of the UAV flight height prediction model comprises:
using, as a set of training samples, the crop lodging information sample and the UAV flight height label corresponding to the crop lodging information sample, to obtain a plurality of sets of training samples; and
training the deep neural network model based on the plurality of sets of training samples, to obtain the UAV flight height prediction model.

20. The UAV flight height control method according to claim 15, wherein a training process of the UAV flight height prediction model comprises:
using, as a set of training samples, the crop lodging information sample and the UAV flight height label corresponding to the crop lodging information sample, to obtain a plurality of sets of training samples; and
training the deep neural network model based on the plurality of sets of training samples, to obtain the UAV flight height prediction model.

21. The UAV flight height control method according to claim 16, wherein the training the deep neural network model based on the plurality of sets of training samples to obtain the UAV flight height prediction model comprises:
inputting any set of training samples, into a deep neural network model that undergoes a current number of times of training, to output a prediction probability corresponding to the training samples under the current number of times of training;
calculating, by using a preset loss function, a loss value under the current number of times of training based on the prediction probability corresponding to the training samples under the current number of times of training and a UAV flight height label corresponding to the training samples;
determining whether a termination condition is met, wherein the termination condition is: the loss value under the current number of times of training is less than a preset threshold or the current number of times of training reaches a preset number of times of training; and
if the termination condition is met, determining, as the UAV flight height prediction model, the deep neural network model that undergoes the current number of times of training; or
if the termination condition is not met, tuning parameters of the deep neural network model that undergoes the current number of times of training, and returning to the step “inputting any set of training samples into a deep neural network model that undergoes a current number of times of training, to output a prediction probability corresponding to the training samples under the current number of times of training”, until the termination condition is met.

22. The UAV flight height control method according to claim 17, wherein the training the deep neural network model based on the plurality of sets of training samples to obtain the UAV flight height prediction model comprises:
inputting any set of training samples, into a deep neural network model that undergoes a current number of times of training, to output a prediction probability corresponding to the training samples under the current number of times of training;
calculating, by using a preset loss function, a loss value under the current number of times of training based on the prediction probability corresponding to the training samples under the current number of times of training and a UAV flight height label corresponding to the training samples;
determining whether a termination condition is met, wherein the termination condition is: the loss value under the current number of times of training is less than a preset threshold or the current number of times of training reaches a preset number of times of training; and
if the termination condition is met, determining, as the UAV flight height prediction model, the deep neural network model that undergoes the current number of times of training; or
if the termination condition is not met, tuning parameters of the deep neural network model that undergoes the current number of times of training, and returning to the step “inputting any set of training samples into a deep neural network model that undergoes a current number of times of training, to output a prediction probability corresponding to the training samples under the current number of times of training”, until the termination condition is met.

23. The UAV flight height control method according to claim 18, wherein the training the deep neural network model based on the plurality of sets of training samples to obtain the UAV flight height prediction model comprises:
inputting any set of training samples, into a deep neural network model that undergoes a current number of times of training, to output a prediction probability corresponding to the training samples under the current number of times of training;
calculating, by using a preset loss function, a loss value under the current number of times of training based on the prediction probability corresponding to the training samples under the current number of times of training and a UAV flight height label corresponding to the training samples;
determining whether a termination condition is met, wherein the termination condition is: the loss value under the current number of times of training is less than a preset threshold or the current number of times of training reaches a preset number of times of training; and
if the termination condition is met, determining, as the UAV flight height prediction model, the deep neural network model that undergoes the current number of times of training; or
if the termination condition is not met, tuning parameters of the deep neural network model that undergoes the current number of times of training, and returning to the step “inputting any set of training samples into a deep neural network model that undergoes a current number of times of training, to output a prediction probability corresponding to the training samples under the current number of times of training”, until the termination condition is met.

24. The UAV flight height control method according to claim 19, wherein the training the deep neural network model based on the plurality of sets of training samples to obtain the UAV flight height prediction model comprises:
inputting any set of training samples, into a deep neural network model that undergoes a current number of times of training, to output a prediction probability corresponding to the training samples under the current number of times of training;
calculating, by using a preset loss function, a loss value under the current number of times of training based on the prediction probability corresponding to the training samples under the current number of times of training and a UAV flight height label corresponding to the training samples;
determining whether a termination condition is met, wherein the termination condition is: the loss value under the current number of times of training is less than a preset threshold or the current number of times of training reaches a preset number of times of training; and
if the termination condition is met, determining, as the UAV flight height prediction model, the deep neural network model that undergoes the current number of times of training; or
if the termination condition is not met, tuning parameters of the deep neural network model that undergoes the current number of times of training, and returning to the step “inputting any set of training samples into a deep neural network model that undergoes a current number of times of training, to output a prediction probability corresponding to the training samples under the current number of times of training”, until the termination condition is met.

25. The UAV flight height control method according to claim 20, wherein the training the deep neural network model based on the plurality of sets of training samples to obtain the UAV flight height prediction model comprises:
inputting any set of training samples, into a deep neural network model that undergoes a current number of times of training, to output a prediction probability corresponding to the training samples under the current number of times of training;
calculating, by using a preset loss function, a loss value under the current number of times of training based on the prediction probability corresponding to the training samples under the current number of times of training and a UAV flight height label corresponding to the training samples;
determining whether a termination condition is met, wherein the termination condition is: the loss value under the current number of times of training is less than a preset threshold or the current number of times of training reaches a preset number of times of training; and
if the termination condition is met, determining, as the UAV flight height prediction model, the deep neural network model that undergoes the current number of times of training; or
if the termination condition is not met, tuning parameters of the deep neural network model that undergoes the current number of times of training, and returning to the step “inputting any set of training samples into a deep neural network model that undergoes a current number of times of training, to output a prediction probability corresponding to the training samples under the current number of times of training”, until the termination condition is met.

26. A UAV flight height control apparatus, comprising:
an obtaining module, configured to obtain crop lodging information of a crop lodging area beneath a UAV during a flight;
a prediction module, configured to input the crop lodging information into a UAV flight height prediction model to obtain a target flight height output by the UAV flight height prediction model, wherein the UAV flight height prediction model is obtained by training a deep neural network model based on a crop lodging information sample and a UAV flight height label corresponding to the crop lodging information sample; and
a control module, configured to control the UAV to fly at the target flight height.

27. An electronic device, comprising a memory, a processor, and a computer program that is stored in the memory and able to run in the processor, wherein when the program is executed by the processor, the UAV flight height control method according to claim 11 is implemented.

28. An electronic device, comprising a memory, a processor, and a computer program that is stored in the memory and able to run in the processor, wherein when the program is executed by the processor, the UAV flight height control method according to claim 12 is implemented.

29. An electronic device, comprising a memory, a processor, and a computer program that is stored in the memory and able to run in the processor, wherein when the program is executed by the processor, the UAV flight height control method according to claim 13 is implemented.

30. A storage medium, storing a computer program, wherein when the computer program is executed by a processor, the UAV flight height control method according to claim 11 is implemented.
